(19) United States
(12) Patent Application Publication
(10) Pub. No.: US 2005/0164032 A1
(43) Pub. Date: Jul. 28, 2005

(54) Organic electroluminescent element

(75) Inventors: Toshihiro Ise, Kanagawa (JP); Tatsuya Igarashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/018,306

(22) Filed: Dec. 22, 2004

(30) Foreign Application Priority Data
Dec. 22, 2003 (JP) 2003-425307

(51) Int. Cl. H05B 33/14

(52) U.S. Cl. 428/690; 428/917; 313/504; 313/506

(57) ABSTRACT

An organic electroluminescent element including: a pair of electrodes and one or more organic compound layers including a luminous layer, the one or more organic compound layers being disposed between the pair of electrodes. The luminous layer includes at least one compound that emits fluorescent light when voltage is applied, the one or more organic compound layers include a compound having a function of amplifying the number of singlet excitons generated when voltage is applied so as to amplify luminous intensity of the fluorescent light emitted from the compound that emits fluorescent light, and the luminous layer includes at least one noncomplex compound represented by the following formula (I) as a host material: 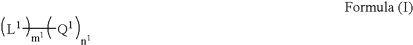
where L¹ represents a connecting group, Q¹ represents a substituent, m¹ denotes 0 or 1, n¹ denotes an integer of 1 or more, and a plurality of Q¹s may be the same or different.

### CROSS-REFERENCE TO RELATED APPLICATION

This application claims priority under 35USC 119 from Japanese Patent Application No. 2003-425307, the disclosure of which is incorporated by reference herein.

### BACKGROUND OF THE INVENTION

1. Field of the Invention

The present invention relates to a luminous element which converts electric energy into light to emit the light, and, particularly, to an organic electroluminescent element (organic EL element).

2. Description of the Related Art

Organic electroluminescent elements (hereinafter referred to as an organic EL element accordingly) have received attention as promising display elements as highly bright emission can be obtained at a low voltage. External quantum efficiency is an important characteristic value of these organic electroluminescent elements. The external quantum efficiency is calculated by the following equation. The larger the value of the external quantum efficiency is, that is, the larger the number of emitted photons is in relation to electrons injected into the element, the more advantageous the element is with regard to power consumption.
External quantum efficiency φ=Number of photons emitted from element/Number of electrons injected into element

The external quantum efficiency of the organic electroluminescent element is specifically determined according to the following equation.
External quantum efficiency φ=Internal quantum efficiency×Light ejection efficiency

In an organic EL element using fluorescent emission from an organic compound, the threshold value of the internal quantum efficiency is 25%, and the light ejection efficiency is 20%. Therefore, the threshold value of the external quantum efficiency is regarded as about 5%.

As a method of improving the external quantum efficiency of an organic electroluminescent element by improving the internal quantum efficiency of the element, an element using a triplet luminous element (phosphorescent light emitting material) has been proposed (see, for example, International Patent Application Publication No. 2000/070655). This element allows improvement in external quantum efficiency over a conventional element (singlet luminous element) utilizing fluorescent emission, and the maximum value of the external quantum efficiency has reached 8% (external quantum efficiency at 100 cd/m²: 7.5%). However, since this element uses phosphorescent emission, the response of the emission is slow, and also, improvement with respect to the durability of the element has been desired.

As a method solving this problem, a singlet luminous element using energy transfer from a triplet exciton to a singlet exciton has been proposed (see, for example, International Patent Application Publication No. 2001/008230). However, the maximum value of the external quantum efficiency of the element described in this document is only 3.3% and therefore does not exceed the external quantum efficiency of a conventional singlet luminous element (φ=5%). Thus, from the standpoint of greater efficiency, further improvement is demanded.

### SUMMARY OF THE INVENTION

The present invention has been made in view of the above-described circumstances and provides an organic electroluminescent element having high luminous efficiency.

An aspect of the invention is to provide an organic electroluminescent element comprising: a pair of electrodes and one or more organic compound layers including a luminous layer, the one or more organic compound layers being disposed between the pair of electrodes. The luminous layer comprises at least one compound that emits fluorescent light when voltage is applied. The one or more organic compound layers comprise a compound having a function of amplifying the number of singlet excitons generated when voltage is applied so as to amplify luminous intensity of the fluorescent light emitted from the compound that emits fluorescent light (hereinafter, this compound is sometimes referred to as “amplifying agent”). The luminous layer comprises at least one noncomplex compound represented by the following formula (I) as a host material: 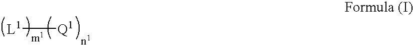
wherein L¹ represents a connecting group, Q¹ represents a substituent, m¹ denotes 0 or 1, n¹ denotes an integer of 1 or more, and a plurality of Q¹s may be the same or different The formula (I) does not represent the following compound(X):

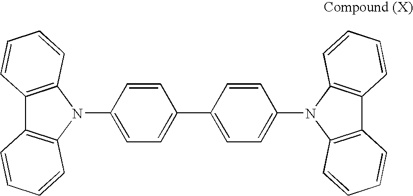

The organic electroluminescent element of the invention has excellent luminous efficiency and can attain high luminous intensity.

The other aspect of the invention is to provide a display including the organic electroluminescent element of the invention.

### BRIEF DESCRIPTION OF THE DRAWING

FIG. 1 is a schematic cross-sectional view illustrating the structure of an example of a light-emtting device of the present invention.

### DETAILED DESCRIPTION OF THE INVENTION

The present invention relates to an organic electroluminescent element comprising a pair of electrodes and one or more organic compound layers including a luminous layer, the one or more organic compound layers being disposed between the pair of electrodes. The luminous layer comprises at least one compound that emits fluorescent light when voltage is applied wherein the emission when voltage is applied is primarily originated from the emission from the fluorescent compound.

The description that the emission when voltage is applied is primarily originated from the emission from the fluorescent compound means that 51% or more of luminous components obtained from the element are emission (fluorescence) from a singlet exciton and 49% or less thereof are emission (phosphorescence) from a triplet exciton. In the invention, it is preferable that 70% or more of luminous components obtained from the element be fluorescence and 30% or less thereof be phosphorescence. It is more preferable that 80% or more thereof be fluorescence and 20% or less thereof be phosphorescence, and it is most preferable that 90% or more thereof be fluorescence and 10% or less thereof be phosphorescence. The reason why it is preferable that the emission is mainly fluorescent emission is because the response and durability of the emission are improved and a reduction in efficiency at the time of high brightness (for example, 1000 cd/m² or more) is reduced.

The organic electroluminescent element of the invention comprises a compound (amplifying agent) having a function of amplifying the number of singlet excitons generated when voltage is applied to amplify the luminous intensity of the fluorescent light emitted from the compound.

The compound contained in the organic compound layers in the luminous element of the invention will be explained below.

Amplifying Agent

Any material may be used without any particular limitation insofar as it amplifies the number of singlet excitons produced when voltage is applied. Examples of the amplifying agent include compounds having a function of transferring energy to a singlet exciton of a host material. Examples of the compound satisfying the function include compounds emitting phosphorescent light (the quantum yield of phosphorescent light is preferably 50% or more, more preferably 70% or more and still more preferably 90% or more), for example, transition metal complexes.

Preferable examples of the transition metal complex include iridium complexes, platinum complexes, rhenium complexes, ruthenium complexes, palladium complexes, rhodium complexes, copper complexes or rare earth complexes. Among them, iridium complexes and platinum complexes are more preferable.

Examples of preferably utilized amplifying agent include those described in patent documents such as U.S. Pat. Nos. 6,303,231 B1, 6,097,147, WO 00/57676, WO 00/70655, WO 01/08230, WO 01/39234 A2, WO 01/41512 A1, WO 02/02714 A2, WO 02/15645 A1, Japanese Patent Application Laid-Open (JP-A) No. 2001-247859, JP-A No. 2002-117978, JP-A No.2002-235076, JP-A No. 2002-170684, EP 1211257, JP-A Nos. 2002-226495, 2002-234894, 2001-247859, 2001-298470, 2002-173674, 2002-203678 and 2002-203679 and non-patent documents such as Nature, vol. 395, page 151 (1998), Applied Physics Letters, vol. 75, page 4 (1999), Polymer Preprints, vol. 41, page 770 (2000), Journal of American Chemical Society, vol. 123, page 4304 (2001) and Applied Physics Letters, vol. 79, page 2082 (1999).

The amplifying agent is contained in at least one layer of the one or more organic compound layers. The amplifying agent may be contained in a luminous layer. There is no limitation to the concentration of the amplifying agent in the one or more organic compound layers. The concentration of the amplifying agent in the one or more organic compound layers is preferably 0.1% by mass or more and 9% by mass or less, more preferably 1% by mass or more and 8% by mass or less, still more preferably 2% by mass or more and 7% by mass or less and particularly preferably 3% by mass or more and 6% by mass or less based on the mass of the one or more organic compound layers in view of luminous efficiency and durability.

Compounds Emitting Fluorescent Light

The fluorescent quantum yield of the fluorescent light-emitting compound used in the invention is preferably 70% or more, more preferably 80% or more, still more preferably 90% or more and most preferably 95% or more. As the fluorescent quantum yield, a value measured at 20° C. in a solid film or in a solution may be used.

The fluorescent light-emitting compound used in the invention is not particularly limited. Examples thereof include benzoxazole, benzoimidazole, benzothiazole, styrylbenzene, polyphenyl, diphenylbutadiene, tetraphenylbutadiene, naphthalimide, cumarin, perylene, perinone, oxadiazole, aldazine, pyralidine, cyclopentadiene, bisstyrylanthracene, rubrene, quinacridone, pyrrolopyridine, thiadiazolopyridine, styrylamine, aromatic dimethylidene compound, metal complexes of 8-quinolinol derivatives, polymer compounds such as a polythiophene, polyphenylene or polyphenylenevinylene or derivatives of these compounds.

The concentration of the fluorescent light-emitting compound in the luminous layer is in a range preferably from 0.0001 to 20% by mass, more preferably from 0.001 to 15% by mass, still more preferably from 0.01 to 12% by mass, even more preferably from 0.1 to 10% by mass, particularly preferably from 0.3 to 8% by mass and most preferably from 0.5 to 5% by mass.

Compound Represented by Formula (I)

The organic electroluminescent element of the invention has the characteristics that the luminous layer contains a noncomplex host material represented by the following formula (I). Namely, the specific host material according to the invention is selected from compounds which have the structure represented by the formula (I) and are not metal complexes.

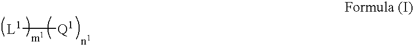

In the formula (I), L¹ represents a connecting group. Q¹ represents a substituent. m¹ denotes 0 or 1, n¹ denotes an integer of 1 or more. When n¹ is 1, L¹ is not a connecting group combining plural Q¹s but a group connected to Q¹. Plural Q¹s may be the same or different. However, the formula (I) never represents the following compound (X).

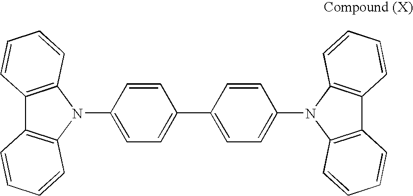

The compound represented by the formula (I) will be explained. L¹ represents a connecting group. L¹ may be a single bond directly connecting Q¹s to each other, or a connecting group formed of carbon, silicon, nitrogen, phosphorus, sulfur, oxygen, boron, germanium or the like. L¹ may be more preferably a single bond, a carbon atom, a silicon atom, a boron atom, an oxygen atom, a sulfur atom, a germanium atom, an aromatic hydrocarbon ring or an aromatic hetero-ring. L¹ may be still more preferably a carbon atom, a silicon atom, an aromatic hydrocarbon ring or an aromatic hetero-ring. Examples of the connecting group represented by L¹ include the following.

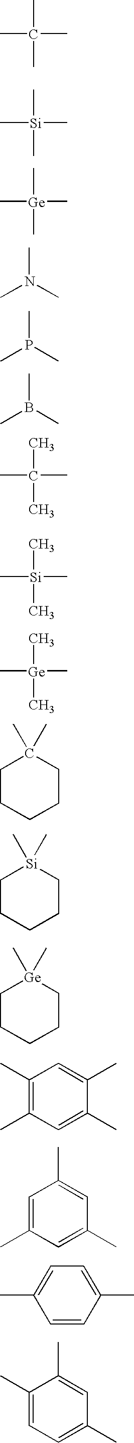

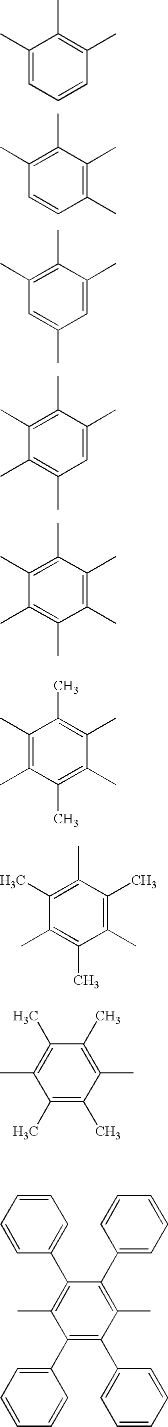

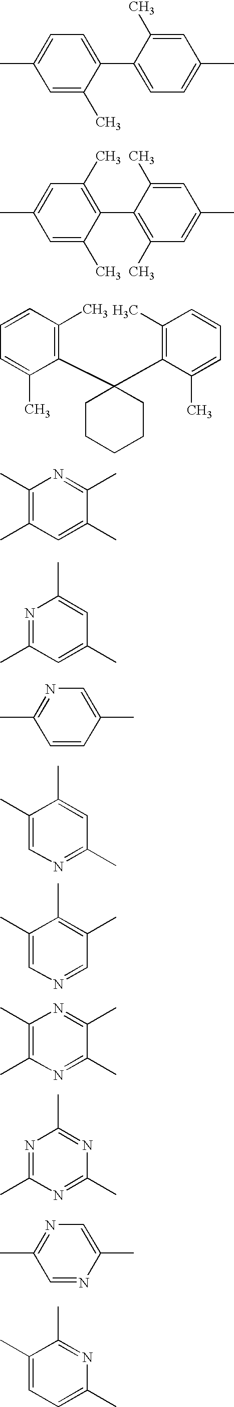

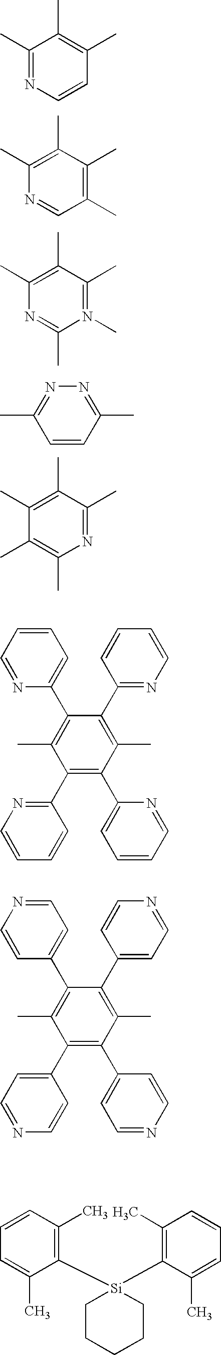

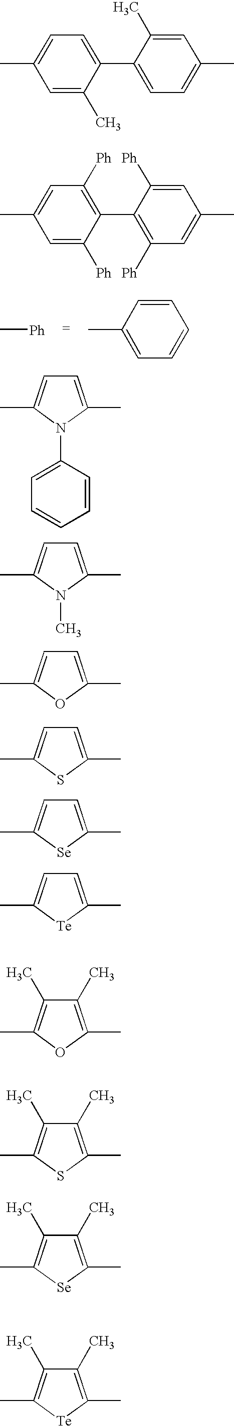

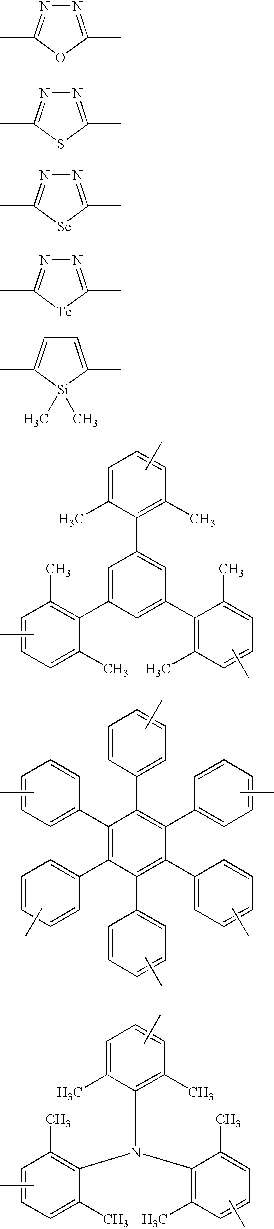

L¹ may further have a substituent. Examples of such a substituent which can be introduced include an alkyl group (having preferably 1 to 30 carbon atoms, more preferably 1 to 20 carbon atoms and particularly preferably 1 to 10 carbon atoms; examples thereof include methyl, ethyl, iso-propyl, tert-butyl, n-octyl, n-decyl, n-hexadecyl, cyclopropyl, cyclopentyl and cyclohexl), an alkenyl group (having preferably 2 to 30 carbon atoms, more preferably 2 to 20 carbon atoms and particularly preferably 2 to 10 carbon atoms; examples thereof include vinyl, allyl, 2-butenyl and 3-pentenyl), an alkenyl group (having preferably 2 to 30 carbon atoms, more preferably 2 to 20 carbon atoms and particularly preferably 2 to 10 carbon atoms; examples thereof include propargyl and 3-pentinyl), an aryl group (having preferably 6 to 30 carbon atoms, more preferably 6 to 20 carbon atoms and particularly preferably 6 to 12 carbon atoms; examples thereof include phenyl, p-methylphenyl, naphthyl and anthranyl), an amino group (having preferably 0 to 30 carbon atoms, more preferably 0 to 20 carbon atoms and particularly preferably 0 to 10 carbon atoms; examples thereof include amino, methylamino, dimethylamino, diethylamino, dibenzylamino, diphenylamino and ditolylamino), an alkoxy group (having preferably 1 to 30 carbon atoms, more preferably 1 to 20 carbon atoms and particularly preferably 1 to 10 carbon atoms; examples thereof include methoxy, ethoxy butoxy and 2-ethylhexyloxy), an aryloxy group (having preferably 6 to 30 carbon atoms, more preferably 6 to 20 carbon atoms and particularly preferably 6 to 12 carbon atoms; examples thereof include phenyloxy, 1-naphthyloxy and 2-naphthyloxy), a heterocyclic oxy group (having preferably 1 to 30 carbon atoms, more preferably 1 to 20 carbon atoms and particularly preferably 1 to 12 carbon atoms, for example, pyridyloxy, pyraziloxy, pyrimidyloxy and quinolyloxy), an acyl group (having preferably 1 to 30 carbon atoms, more preferably 1 to 20 carbon atoms and particularly preferably 1 to 12 carbon atoms, for example, acetyl, benzoyl, formyl and pivaloyl), an alkoxycarbonyl group (having preferably 2 to 30 carbon atoms, more preferably 2 to 20 carbon atoms and particularly preferably 2 to 12 carbon atoms, for example, methoxycarbonyl and ethoxycarbonyl group), an aryloxycarbonyl group (having preferably 7 to 30 carbon atoms, more preferably 7 to 20 carbon atoms and particularly preferably 7 to 12 carbon atoms, for example, phenyloxycarbonyl), an acyloxy group (having preferably 2 to 30 carbon atoms, more preferably 2 to 20 carbon atoms and particularly preferably 2 to 10 carbon atoms, for example, acetoxy and benzoyloxy), an acylamino group (having preferably 2 to 30 carbon atoms, more preferably 2 to 20 carbon atoms and particularly preferably 2 to 10 carbon atoms, for example, acetylamino and benzoylamino), an alkoxycarbonylamino group (having preferably 2 to 30 carbon atoms, more preferably 2 to 20 carbon atoms and particularly preferably 2 to 12 carbon atoms, for example, methoxycarbonylamino), an aryloxycarbonylamino group (having preferably 7 to 30 carbon atoms, more preferably 7 to 20 carbon atoms and particularly preferably 7 to 12 carbon atoms, for example, phenyloxycarbonylamino), a sulfonylamino group (having preferably 1 to 30 carbon atoms, more preferably 1 to 20 carbon atoms and particularly preferably 1 to 12 carbon atoms, for example, methanesulfonylamino and benzenesulfonylamino), a sulfamoyl group (having preferably 0 to 30 carbon atoms, more preferably 0 to 20 carbon atoms and particularly preferably 0 to 12 carbon atoms, for example, sulfamoyl, methylsulfamoyl, dimethylsulfamoyl and phenylsulfamoyl); a carbamoyl group (having preferably 1 to 30 carbon atoms, more preferably 1 to 20 carbon atoms and particularly preferably 1 to 12 carbon atoms, for example, carbamoyl, methylcarbamoyl, diethylcarbamoyl and phenylcarbamoyl), an alkylthio group (having preferably 1 to 30 carbon atoms, more preferably 1 to 20 carbon atoms and particularly preferably 1 to 12 carbon atoms, for example, methylthio and ethylthio), an arylthio group (having preferably 6 to 30 carbon atoms, more preferably 6 to 20 carbon atoms and particularly preferably 6 to 12 carbon atoms, for example, phenylthio), a heterocyclic thio group (having preferably 1 to 30 carbon atoms, more preferably 1 to 20 carbon atoms and particularly preferably 1 to 12 carbon atoms, for example, pyridylthio, 2-benzimidazolylthio, 2-benzoxazolylthio and 2-benzthiazolylthio), a sulfonyl group (having preferably 1 to 30 carbon atoms, more preferably 1 to 20 carbon atoms and particularly preferably 1 to 12 carbon atoms, for example, mesyl and tosyl), a sulfinyl group (having preferably 1 to 30 carbon atoms, more preferably 1 to 20 carbon atoms and particularly preferably 1 to 12 carbon atoms, for example, methanesulfinyl and benzenesulfinyl), an ureide group (having preferably 1 to 30 carbon atoms, more preferably 1 to 20carbon atoms and particularly preferably 1 to 12 carbon atoms, for example, ureide, methylureide and phenylureide), a phosphoric acid amide group (having preferably 1 to 30 carbon atoms, more preferably 1 to 20 carbon atoms and particularly preferably 1 to 12 carbon atoms, for example, diethylphosphoric acid amide and phenylphosphoric acid amide), a hydroxy group, a mercapto group, a halogen atom (for example, a fluorine atom, a chlorine atom, a bromine atom and an iodine atom), a cyano group, a sulfo group, a carboxyl group, a nitro group, a hydroxam acid group, a sulfino group, a hydrazino group, an imino group, a heterocyclic group (having preferably 1 to 30 carbon atoms and more preferably 1 to 12 carbon atoms, examples of the hetero atom include a nitrogen atom, an oxygen atom and a sulfur atom, specifically, imidazolyl, pyridyl, quinolyl, furyl, thienyl, piperidyl, morpholino, benzoxazolyl, benzimidazolyl, benzthiazolyl, carbazolyl group and azevinyl group), a silyl group (having preferably 3 to 40 carbon atoms, more preferably 3 to 30 carbon atoms and particularly preferably 3 to 24 carbon atoms, for example, trimethylsilyl and triphenylsilyl) and a silyloxy group (having preferably 3 to 40 carbon atoms, more preferably 3 to 30 carbon atoms and particularly preferably 3 to 24 carbon atoms, for example, trimethylsilyloxy and triphenylsilyloxy). These substituents may be further substituted. The substituents are preferably an all group, aryl group, heterocyclic group, halogen atom and silyl group, preferably an alkyl group, aryl group, heterocyclic group and halogen atom and still more preferably an alkyl group, aryl group, aromatic heterocyclic group and fluorine atom.

Q¹ represents a substituent, n¹ denotes an integer of 1 or more. When plural Q¹s exist (that is, n¹ is 2 or more), plural Q¹s may be the same or different. Preferable examples of the substituent represented by Q¹ include an aliphatic hydrocarbon group, an aryl group, an aromatic heterocyclic group and a group represented by N(R¹)R².

The aliphatic hydrocarbon group represented by Q¹ may be a straight-chain, branched or cyclic. The aliphatic hydrocarbon group represented by Q¹ is preferably an alkyl group (having preferably 1 to 30 carbon atoms, more preferably 1 to 20 carbon atoms and particularly preferably 1 to 10 carbon atoms, for example, methyl, ethyl, isopropyl, tert-butyl, n-octyl, n-decyl, cyclopentyl and cyclohexyl), an alkenyl group (having preferably 2 to 30 carbon atoms, more preferably 2 to 20 carbon atoms and particularly preferably 2 to 12 carbon atoms, for example, vinyl, allyl, 2-butenyl and 3-pentenyl), an alkinyl group (having preferably 2 to 30 carbon atoms, more preferably 2 to 20 carbon atoms and particularly preferably 2 to 12 carbon atoms, for example, propargyl and 3-pentinyl). Among them, the aliphatic hydrocarbon group represented by Q¹ is more preferably an alkyl group or an alkenyl group; and still more preferably an alkyl group.

The aryl group represented by Q¹ is preferably an aryl group of a single ring or of condensed rings obtained by the condensation of two or more rings. Such an aryl group has preferably 6 to 30 carbon atoms, more preferably 6 to 20 carbon atoms and particularly 6 to 12 carbon atoms. Examples of such an aryl group include phenyl, naphthyl, anthryl, phenantyl, pyrenyl, triphenylenyl and preferably phenyl, naphthyl, phenanthryl and triphenylenyl.

The aromatic heterocyclic group represented by Q¹ may be a heterocyclic group of a single ring or of condensed rings obtained by the condensation of two or more rings. Such an aromatic heterocyclic group has preferably. 1 to 20 carbon atoms, more preferably 2 to 12 carbon atoms and still more preferably 2 to 10 carbon atoms. Preferable examples of such a heterocyclic group include an aromatic heterocyclic group containing at least one of a nitrogen atom, oxygen atom and sulfur atom. Specific examples of such a heterocyclic group represented by Q¹ include a pyridyl group, quinolyl group, isoquinolyl group, acridinyl group, phenanethridinyl group, pteridinyl group, pyrazyl group, quinoxalinyl group, pyriridinyl group, quinazolyl group, pyrdazinyl group, cinnolinyl group, phthalazinyl group, trazinyl group, oxazolyl group, benzoxazolyl group, thiazolyl group, benzothiazolyl group, imidazolyl group, benzoimidazolyl group, pyrazolyl group, indazolyl group, isoxazolyl group, benzoisoxazolyl group, isothiazolyl group, benzoisothiazolyl group, oxadiazolyl group, thiadiazolyl group, triazolyl group, tetrazolyl group, furyl group, benzofuryl group, thienyl group, benzothienyl group, pyrrolyl group, indolyl group, imidazopyridinyl group and carbazolyl group. Preferable examples of such a heterocyclic group include a pyridyl group, pyrazinyl group, pyrimidinyl group, pyridazinyl group, triazinyl group, oxazolyl group, benzoxazolyl group, thiazolyl group, benzothiazolyl group, imidazolyl group, benzoimidazolyl group, pyrazolyl group, indazolyl group, oxadiazolyl group, thiadiazolyl group, triazolyl group, furyl group, thienyl group, pyrrolyl group, indolyl group, imidazopyridinyl group and carbazolyl group. More preferable examples of such a heterocyclic group include a pyridyl group, pyrazinyl group, triazinyl group, benzoxazolyl group, benzothiazolyl group, benzoimidazolyl group, pyrazolyl group, furyl group, thienyl group, pyrrolyl group, indolyl group and imidazopyridinyl group.

When the group represented by Q¹ is represented by —N(R¹)R², R¹ and R², which may be the same or different, each independently represent an aliphatic hydrocarbon group, an aryl group or a heterocyclic group. R¹ and R² may be bonded to each other to form a ring if possible.

Examples of such an aliphatic hydrocarbon group represented by R¹ or R² include those given as the examples of the aliphatic hydrocarbon group represented by Q¹ and the preferable range is also the same.

As the aryl group represented by R¹ or R², those given as the examples of the aryl group represented by Q¹ may also be applied and the preferable range is also the same.

The heterocyclic group represented by R¹ or R² may be a heterocyclic group constituted of a single ring or condensed rings obtained by the condensation of two or more rings. Such a heterocyclic group is preferably a heterocyclic group having preferably 1 to 20 carbon atoms, more preferably 1 to 12 carbon atoms and still more preferably 2 to 10 carbon atoms. The heterocyclic group is preferably an aromatic heterocyclic group containing at least one of a nitrogen atom, oxygen atom and sulfur atom. Specific examples of such a heterocyclic group represented by R¹ or R² include pyrrolidinyl group, piperidinyl group, pyridyl group, quinolyl group, isoquinolyl group, acridinyl group, phenanethridinyl group, pteridinyl group, pyrazinyl group, quinoxalinyl group, pyrimidinyl group, quinazolyl group, pyridazinyl group, cinnolinyl group, phthalazinyl group, triazinyl group, oxazolyl group, benzoxazolyl group, thiazolyl group, benzothiazolyl group, imidazolyl group, benzoimidazolyl group, pyrazolyl group, indazolyl group, isoxazolyl group, benzoisoxazolyl group, isothiazolyl group, benzoisothiazolyl group, oxadiazolyl group, thiadiazolyl group, triazolyl group, tetrazolyl group, purinyl group, furyl group, benzofuryl group, thienyl group, benzothienyl group, pyrrolyl group, indolyl group, imidazopyridinyl group and carbazolyl group. A pyridyl group, pyrazinyl group and thienyl group are preferable.

The aliphatic hydrocarbon group, aryl group and heterocyclic group represented by R¹ or R² may have a substituent. As such a substituent, those given as the examples of the substituent of L¹ may be used. The substituent is preferably an alkyl group, aryl group, heterocyclic group, amino group or halogen atom, more preferably an alkyl group, aryl group, heterocyclic group or amino group, and still more preferably an alkyl group having 1 to 6 carbon atoms (e.g., methyl, tert-butyl and cyclohexyl), an aryl group having 6 to 20 carbon atoms (e.g., phenyl and naphthyl), a dialkylamino group having 2 to 8 carbon atoms (e.g., dimethylamino and diethylamino), an N-alkyl-N-arylamino group having 7 to 15 carbon atoms (e.g., N-methyl-N-phenylamino), a diarylamino group having 2 to 28 carbon atoms (e.g., diphenylamino, N-(3-methylphenyl)-N-phenylamino) or a fluorine atom.

When R¹ and R² are not bonded to each other to form a ring, R¹ and R² each independently represent preferably an aryl group or an aromatic heterocyclic group, more preferably an aryl group, still more preferably a substituted or unsubstituted phenyl group and particularly preferably an unsubstituted, alkyl-substituted or aryl-substituted phenyl group.

When R¹ and R² are bonded to each other to form a ring, the number of rings is preferably 5 to 7. Examples of such rings formed of R¹, R² and an N atom include a pyrrole ring, indole ring, carbazole ring, dibenzoazepin ring, tribenzoazepin ring, phenothiazine ring and phenoxazine ring. Among them an indole ring, carbazole ring and tribenzoazepin ring are preferable.

The group represented by Q¹ may further have a substituent. As such a substituent, those given as the examples of the substituent L¹ may be used. The substituent of Q¹ is preferably an alkyl group, axyl group, heterocyclic group or halogen atom and more preferably an alkyl group, aryl group, aromatic heterocyclic group or fluorine atom. The formula (I) never represents the following compound (X).

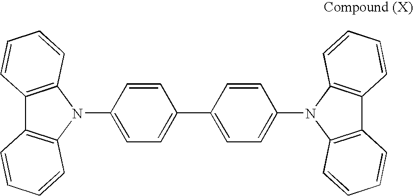

Preferable embodiments of the compound represented by the formula (I) include compounds represented by the following formula (A-I), (B-I) or (C-I).

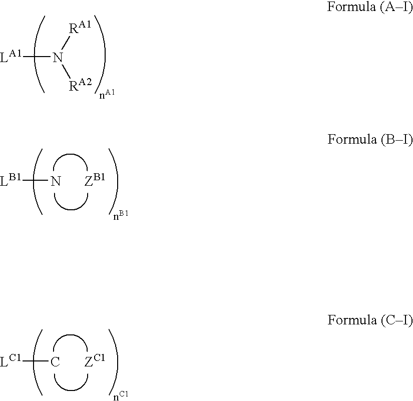

L^{A1} in the formula (A-I) represents a connecting group. As such a connecting group represented by L^{A1}, those given as specific examples of the connecting group L¹ in the formula (I) may be used. L^{A1} is preferably an aromatic hydrocarbon ring having two or more valences, aromatic hetero-rings having two or more valences and carbon atom, more preferably hydrocarbon rings having two or more valences and aromatic hetero-rings having two or more valences and still more preferably a 1,3,5-benzenetriyl group, 1,2,5,6-benzenetetrayl group, 1,2,3,4,5,6-benzenehexayl group, 2,2′-dimethyl-4,4′-biphenylene group, 2,4,6-pyridinetriyl group, 2,3,4,5,6-pyridinepentayl group, 2,4,6-pyrimidinetriyl group, 2,4,6-triazinetriyl group and 2,3,4,5-thiophenetetrayl group.

R^{A1} and R^{A2}, which may be the same or different, each independently represent an aliphatic hydrocarbon group, an aryl group or an aromatic heterocyclic group. R^{A1} and L^{A1} and/or R^{A2} and L^{A1} may be bonded to each other to form a ring if possible, while R^{A1} and R^{A2} are never bonded to each other to form a ring.

As the aliphatic hydrocarbon group represented by R^{A1} or R^{A2}, those given as the examples of the aliphatic hydrocarbon group represented by Q¹ in the formula (I) may be used and the preferable range is also the same.

As the aryl group represented by R^{A1} or R^{A2}, those given as the examples of the aryl group represented by Q¹ in the formula (I) may be used and the preferable range is also the same.

As the heterocyclic group represented by R^{A1} or R^{A2}, those given as the examples of the heterocyclic group represented by Q¹ in the formula (I) may be used and the preferable range is also the same.

R^{A1} and R^{A2} each independently represent preferably an aryl group or an aromatic heterocyclic group, more preferably an aryl group, still more preferably a substituted or unsubstituted phenyl group and particularly preferably an unsubstituted, alkyl-substituted or aryl-substituted phenyl group.

The substituent represented by R^{A1} or R^{A2} may further have a substituent. As the substituent, those given as the examples of the substituent of Q¹ in the formula (I) may be used and the preferable range is also the same.

n^{A1} denotes an integer of 2 or more and is preferably 2 to 8 and more preferably 2 to 6.

Next, the compound represented by the formula (B-I) will be explained.

L^{B1} in the formula (B-I) represents a connecting group. As the connecting group represented by L^{B1}, those given as the specific examples of the connecting group L¹ in the formula (I) may be used. L^{B1} is preferably aromatic hydrocarbon rings having two or more valences, aromatic hetero-rings having two or more valences and carbon atom, more preferably hydrocarbon rings having two or more valences and aromatic hetero-rings having two or more valences and still more preferably a 1,3,5-benzenetriyl group, 1,2,5,6-benzenetetrayl group, 1,2,3,4,5,6-benzenehexayl group, 2,2′-dimethyl-4,4′-biphenylene group, 2,4,6-pyridinetriyl group, 2,3,4,5,6-pyridinepentayl group, 2,4,6-pyrimidinetriyl group, 2,4,6-triazinetriyl group and 2,3,4,5-thiophenetetrayl group.

L^{B1} may further have a substituent. As such a substituent, those given as the examples of the substituent of L¹ in the formula (I) may be used and the preferable range is also the same.

Z^{B1} represents an atomic group necessary for forming the nitrogen-containing hetero-ring. The nitrogen-containing hetero-ring may be either a single ring or condensed rings obtained by the condensation of two or more rings. The nitrogen-containing hetero-ring comprising Z^{B1} is preferably a five- to eight-membered nitrogen-containing hetero-ring and preferably a five-membered nitrogen-containing hetero-ring. The plural nitrogen-containing hetero-rings comprising Z^{B1} and directly connected to L^{B1} may be the same or different.

Specific examples of the nitrogen-containing hetero-rings comprising Z^{B1} include a pyrrole ring, indole ring, azaindole ring, carbazole ring, carboline ring (norharman ring), imidazole ring, benzoimidazole ring, imidazopyridine ring, purine ring, pyrazole ring, indazole ring, azaindazole ring, triazole ring, tetrazole ring, azepin ring, iminostilbene ring (dibenzoazepin ring), tribenzoazepin ring, phenothiazine ring and phenoxazine ring. A pyrrol ring, indole ring, carbazole ring, benzoimidazole ring, imidazopyridine ring and tribenzoazepin ring are preferable and an indole ring, carbazole ring, benzoimidazole ring and tribenzoazepin ring are more preferable.

Z_{B1} may further form condensed rings with another ring and also may have a substituent. As the substituent, those given as the examples of the substituent of Q¹ in the formula (I) may be used and the preferable range is also the same.

n^{B1} denotes an integer of 2 or more, preferably 2 to 8 and more preferably 2 to 6.

Next, the compound represented by the formula (C-1) will be explained.

L^{C1} in the formula (C-I) represents a connecting group. As such a connecting group represented by L^{C1}, those given as the specific examples of the connecting group L¹ may be used. L^{C1} is preferably a single bond, aromatic hydrocarbon ring having two or more valences, aromatic hetero-ring having two or more valences, carbon atom, nitrogen atom or silicon atom, more preferably a hydrocarbon ring having two or more valences or aromatic hetero-ring having two or more valences and still more preferably a 1,3,5-benzenetriyl group, 1,2 5,6-benzenetetrayl group, 1,2,3,4,5,6-benzenehexayl group, 2,2′-dimethyl-4,4′-biphenylene group, 2,4,6-pyridinetriyl group, 2,3,4,5,6-pyridinepentayl group, 2,4,6-pyrmidinetriyl group, 2,4,6-triazinetriyl group, 2,3,4,5-thiophenetetrayl group, carbon atom, nitrogen atom or silicon atom.

L^{C1} may further have a substituent. As such a substituent, those given as the examples of the substituent of L¹ in the formula (I) may be used and the preferable range is also the same.

Z^{C1} represents an atomic group necessary for forming the aromatic hydrocarbon ring or aromatic hetero-ring. The aromatic hydrocarbon ring or aromatic hetero-ring comprising Z^{C1} may be either a single ring or condensed rings obtained by the condensation of two or more rings. The plural aromatic hydrocarbon rings or aromatic hetero-rings comprising Z^{C1} and directly connected to L^{C1}′may be the same or different.

The aromatic hydrocarbon ring comprising Z^{C1} has preferably 6 to 30 carbon atoms, more preferably 6 to 20 carbon atoms and particularly preferably 6 to 12 carbon atoms. Examples of the aromatic hydrocarbon ring include a benzene ring, naphthalene ring, anthracene ring, phenanthrene ring, pyrene ring and triphenylene ring. Among them, a benzene ring, naphthalene ring, phenanthrene ring and triphenylene ring are preferable.

The aromatic hetero ring comprising Z^{C1} is a hetero-ring constituted of a single ring or condensed rings obtained by the condensation of two or more rings and is an aromatic hetero ring having preferably 1 to 20 carbon atoms, more preferably 2 to 12 carbon atoms and still more preferably 2 to 10 carbon atoms. The hetero-ring is preferably an aromatic hetero-ring containing at least one of a nitrogen atom, oxygen atom and sulfur atom. Specific examples of such a hetero-ring comprising Z^{C1} include a pyridine ring, quinoline ring, isoquinoline ring, acridine ring, phenanthridine ring, pteridine ring, pyrazine ring, quinoxaline ring, pynidine ring, quinazolind ring, pyridazine ring, cinnoline ring, phthalazine ring, triazine ring, oxazole ring, benzoxazole ring, thiazole ring, benzothiazole ring, imidazole ring, benzoimidazole ring, pyrazole ring, indazole ring; isoxazole ring, benzoisoxazole ring, isothiazole ring, benzoisothiazole ring, oxadiazole ring, thiadiazole ring, triazole ring, tetrazole ring, furan ring, benzofuran ring, thiophene ring, benzothiophene ring, pyrrole ring, indole ring, imidazopyridine ring and carbazole ring. Among these rings, a pyridine ring, pyrazine ring, pyrimidine ring, pyndazine ring, triazine ring, oxazole. ring, benzoxazole ring, thiazole ring, benzothiazole ring, inudazole ring, benzoimidazole ring, pyrazole ring, indazole ring, oxadiazole ring, thiadiazole ring, triazole ring, furan ring, thiophene ring, pyrrole ring, indole ring, imidazopyridine ring and carbazole ring are preferable. Moreover, a pyridine ring, pyrazine ring, triazine ring, benzoxazole ring, benzothiazole ring, benzoimidazole ring, pyrazole ring, furan ring, thiophene ring, pyrrole ring, indole ring and imidazopyridine ring are more preferable.

The aromatic hydrocarbon ring and aromatic hetero-ring comprising Z^{C1} may further form condensed rings with another ring and may also have a substituent. As such a substituent, those given as the examples of the substituent of Q¹ in the formula (I) may be used and the preferable range is also the same.

n^{C1} denotes an integer of 2 or more, preferably 2 to 8 and more preferably 2 to 6.

The compound represented by the formula (I) according to the invention may be a low-molecular compound or may be an oligomer compound or a polymer compound in which the compound represented by the formula (I) is introduced into its principal chain or side chain. When the compound represented by the formula (I) is a polymer compound, the weight average molecular weight (based on polystyrene) is preferably 1,000 to 5,000,000, more preferably 2,000 to 1,000,000 and still more preferably 3,000 to 100,000. In the invention, the compound represented by the formula (I) is preferably a low-molecular compound, which has a molecular weight of preferably about 200 to 3,000, more preferably in a range of about 300 to 2,000 and particularly preferably in a range of about 350 to 1,500.

Specific examples (exemplified compounds (1) to (60)) of the compound represented by the formula (I) will be listed below; however, these examples should not be construed to limit the scope of the invention.

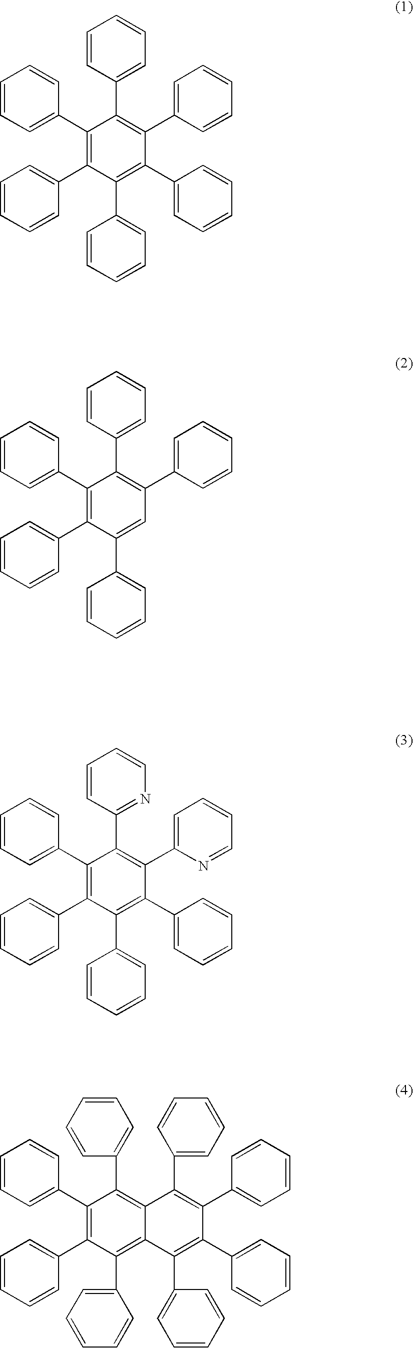

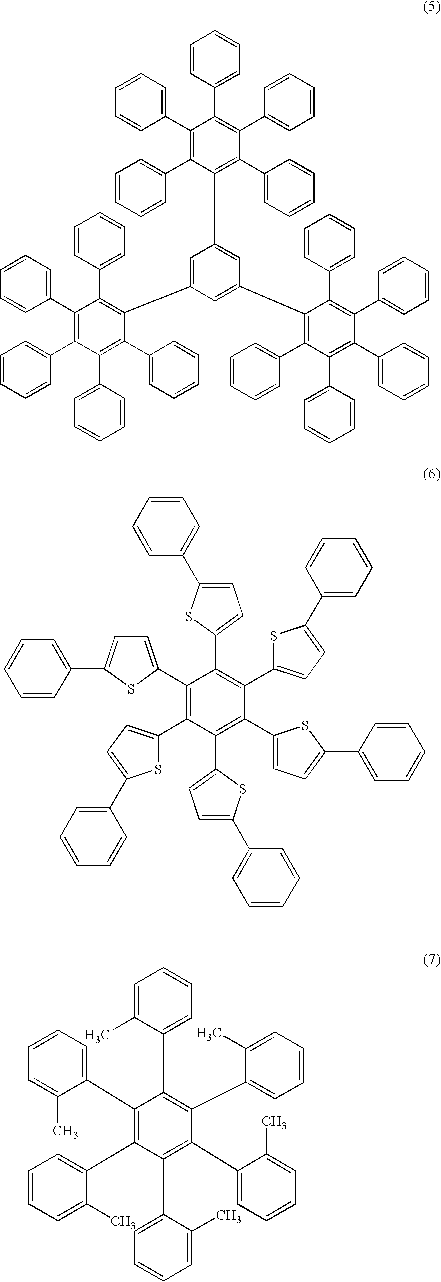

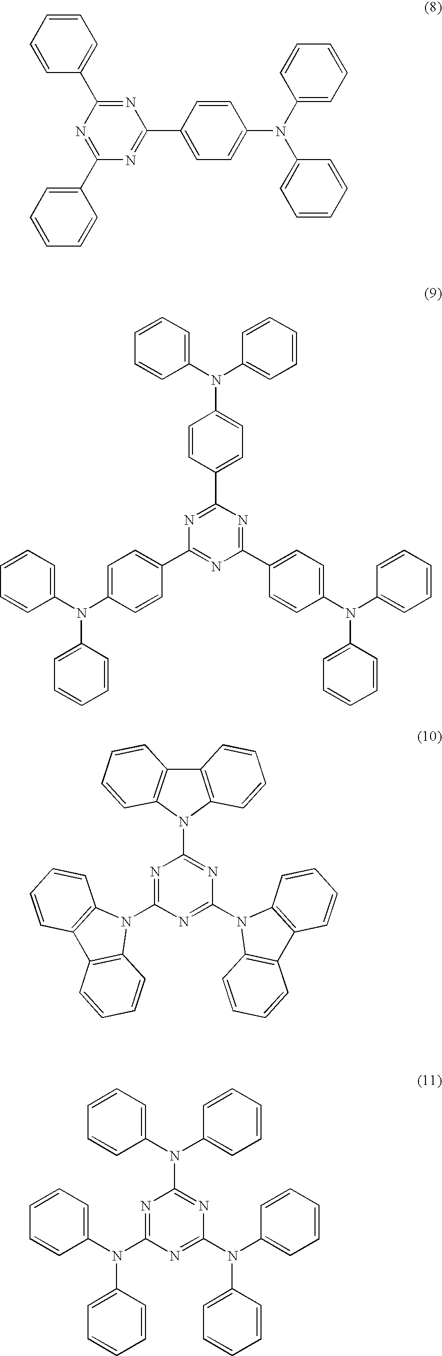

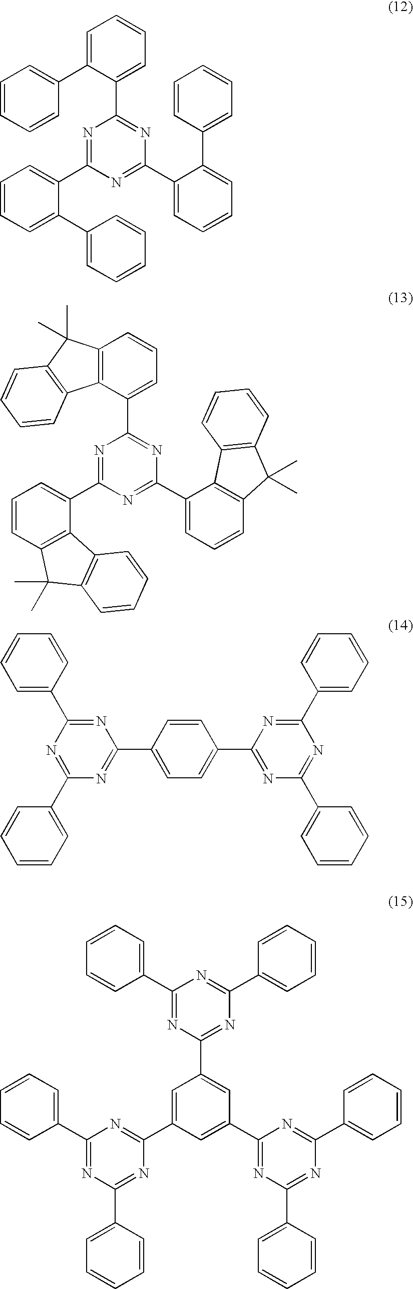

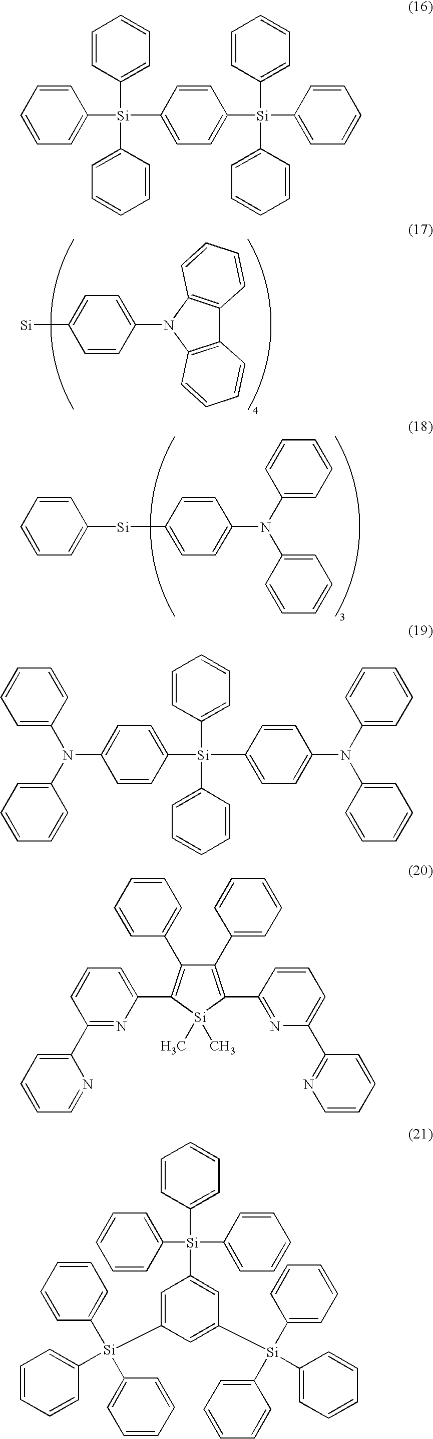

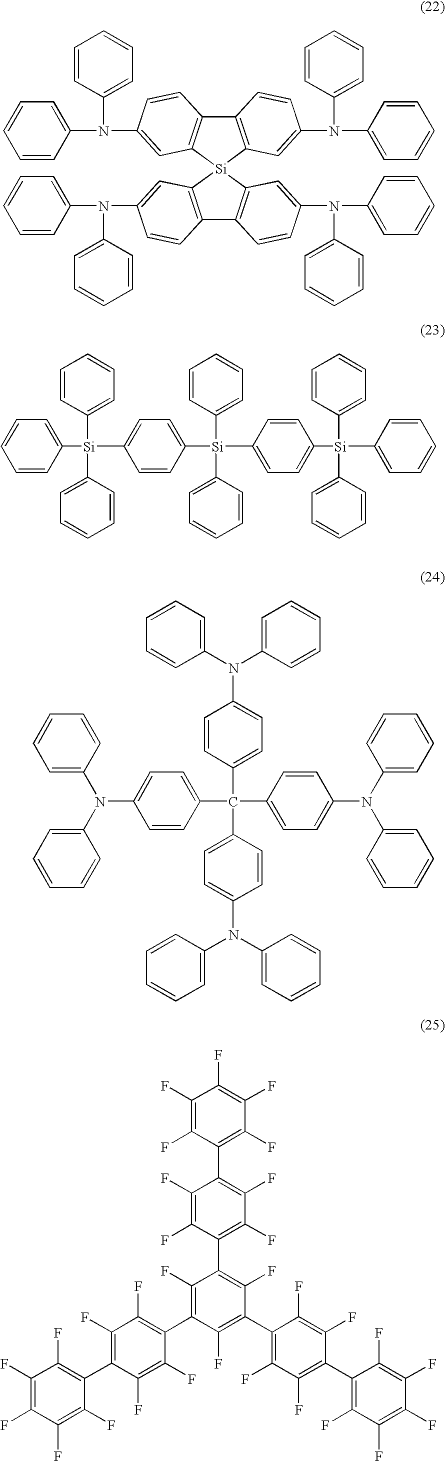

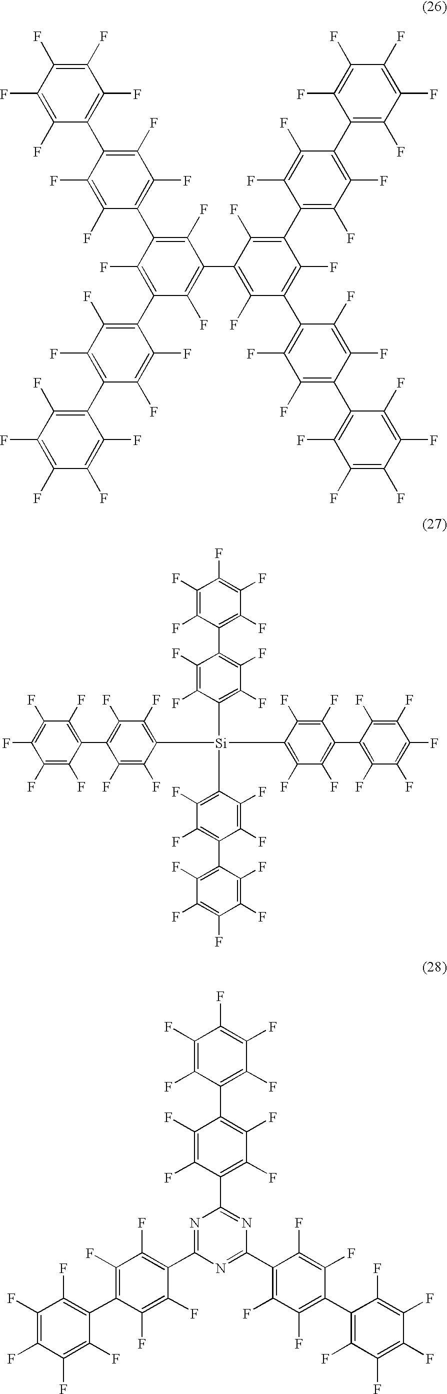

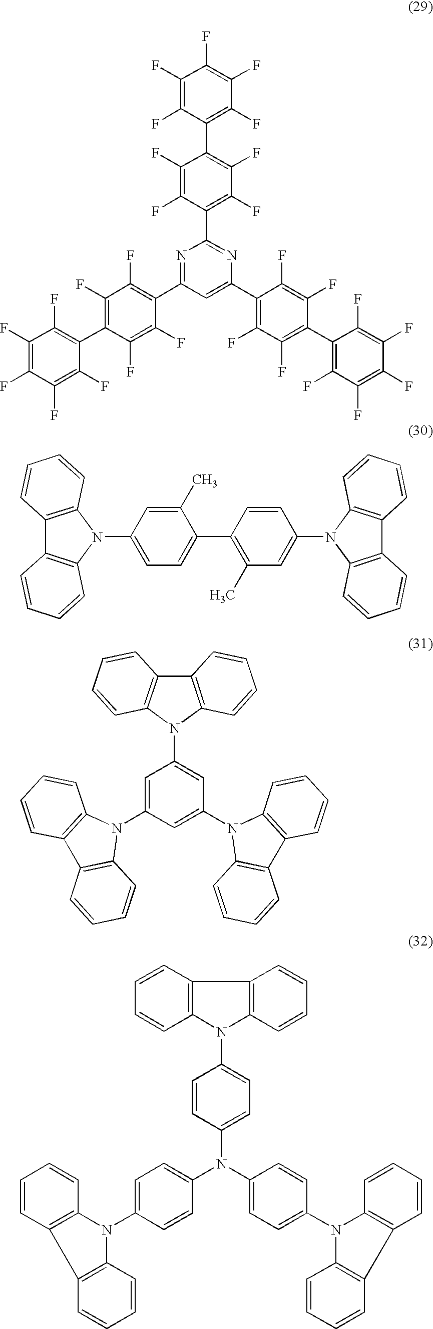

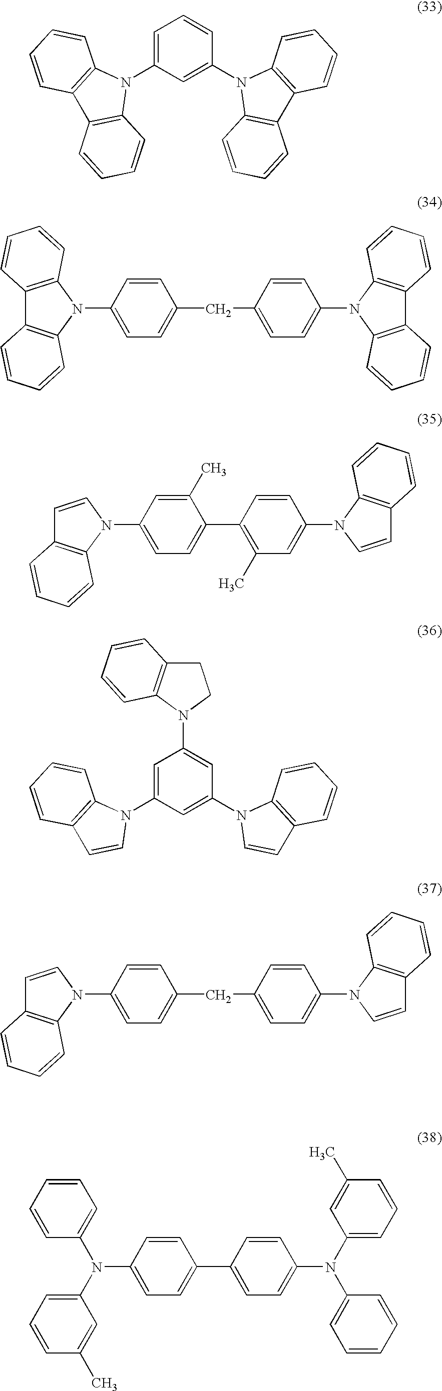

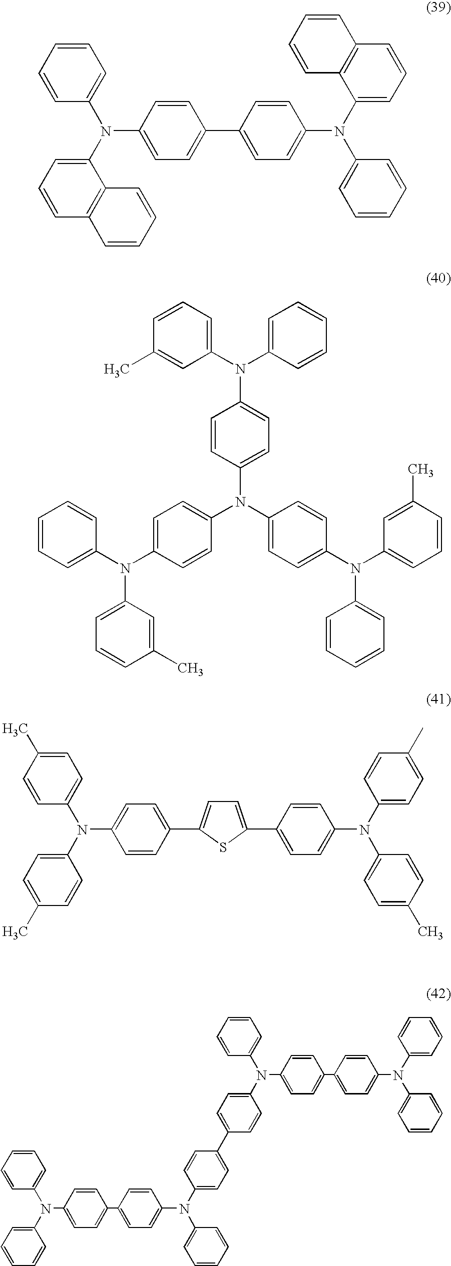

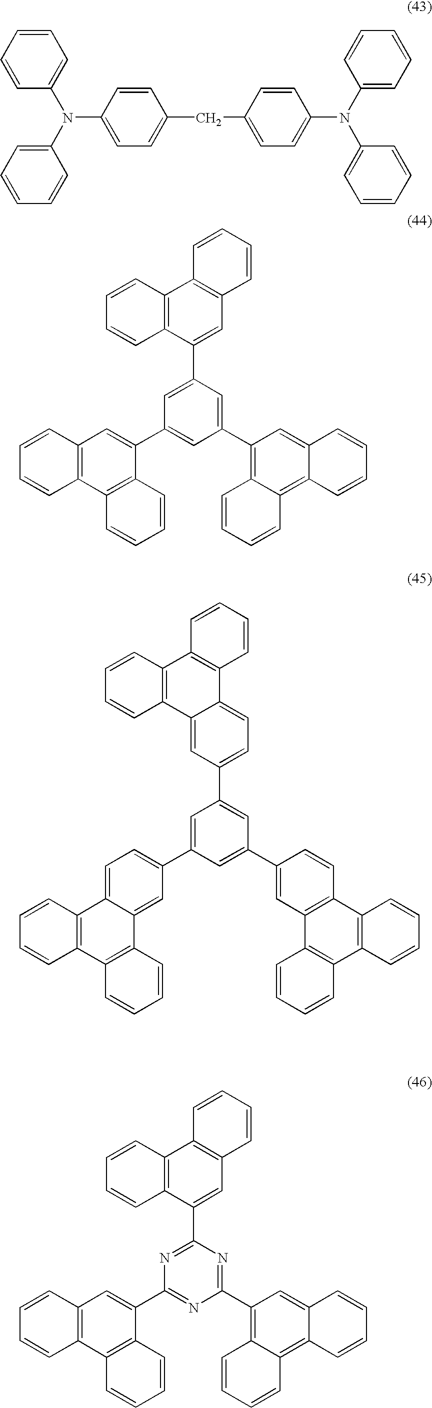

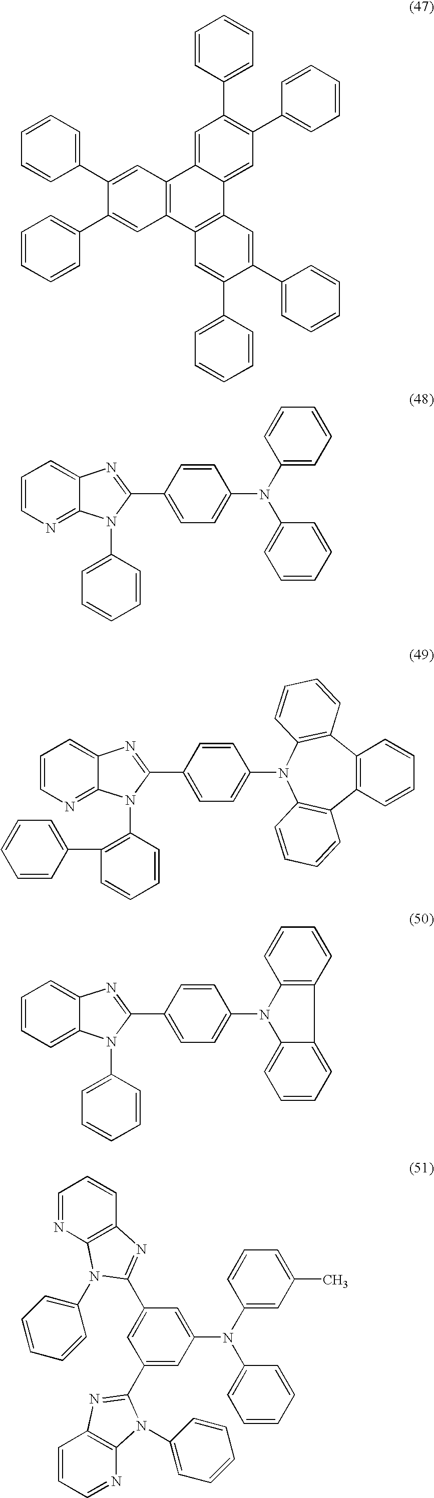

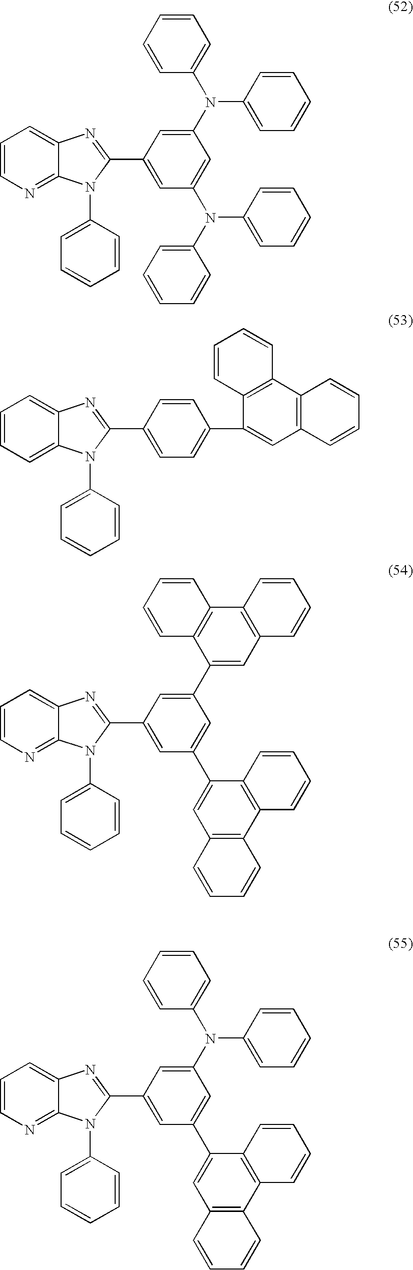

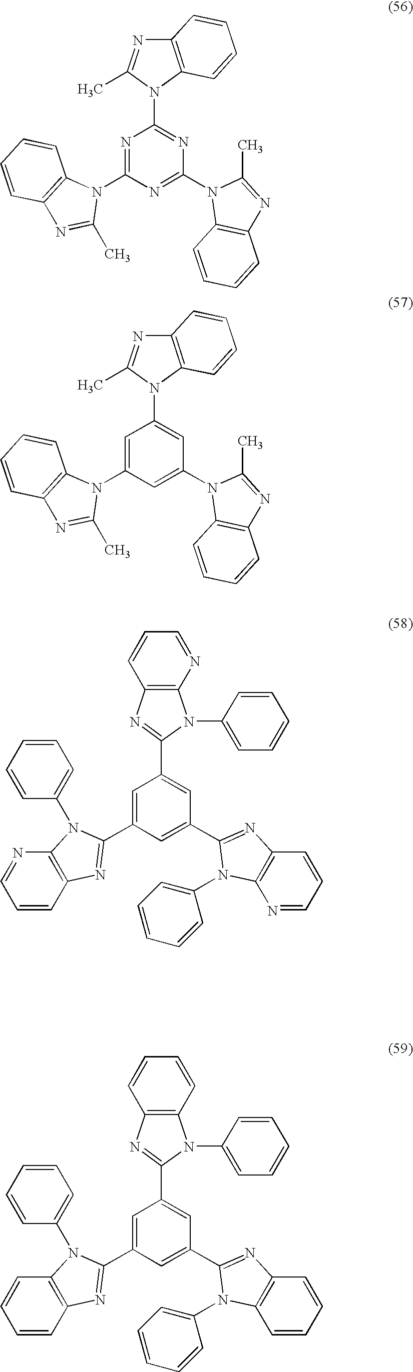

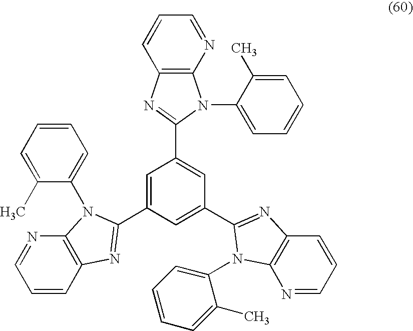

Specific examples of the compounds represented by the formula (I) include, besides the above-exemplified compounds, the compounds (1-1) to (1-34) described in JP-A No. 2003-27048, the compounds (A-1) to (A-33), (B-1) to (B-62), (C-1) to (C-72), (D-1) to (D-75) and (E-1) to (E-5) described in JP-A No. 2002-100476, the exemplified compounds 1 to 60 described in JP-A No. 2002-193952, the compounds 1 to 381 described in JP-A No. 2002-319491, the compounds 1 to 37 described in JP-A No. 2000-119644, the compounds 1 to 58 described in JP-A No. 2003-217856, the compounds 1 to 26 described in JP-A No. 2004-95262, the compounds 1 to 82 described in JP-A No. 2002-38141, the compounds 1 to 47 described in JP-A No. 2001-24758, the compounds 1 to 99 described in JP-A No. 2001-192653, the compounds (HT-1) to (HT-20) described in JP-A No. 2001-284051, the compounds (H-1) to (H-24) described in the specification of JP-A No. 2003-335753, the compounds (H-1) to (H-26) described in the specification of JP-A No.2003-335754, the compounds (E-1) to (E66) described in JP-A No. 2002-338579, the compounds (E-1) to (E-53) described in JP-A No. 2002-356489, the compounds (1-1) to (1-44) described in JP-A No. 2001-192651, the compounds (1-1) to (1-30), (2-1) to (2-22), (3-1) to (3-13), (4 -1) to (4-35) and (5-1) to (5-8) described in JP-A No. 12-351966, the compounds (1-1) to (1-26) described in JP-A No. 2001-192652 and the compounds (H-1) to (H-38) described in JP-A No. 2002-305084.

The electron mobility of the host material used in the invention is preferably 1×10⁻⁶ Vs/cm or more and 1×10⁻¹ Vs/cm or less, more preferably 5×10⁻⁶ Vs/cm or more and 1×10⁻² Vs/cm or less, still more preferably 1×10⁻⁵ Vs/cm or more and 1×10⁻² Vs/cm or less and particularly preferably 5×10⁻⁵ Vs/cm or more and 1×10⁻² Vs/cm or less.

The hole mobility of the host material used in the invention is preferably 1×10⁻⁶ Vs/cm or more and 1×10⁻¹ Vs/cm or less, more preferably 5×10⁻⁶ Vs/cm or more and 1×10⁻² Vs/cm or less, still more preferably 1×10⁻⁵ Vs/cm or more and 1×10⁻² Vs/cm or less and particularly preferably 5×10⁻⁵ Vs/cm or more and 1×10⁻² Vs/cm or less.

The concentration of the host material represented by the formula (I) according to the invention in the layer is not particularly limited; but preferably 80 to 99.9999% by mass, more preferably 85 to 99.999% by mass, still more preferably 88 to 99.99% by mass, even more preferably 90 to 99.9% by mass, particularly preferably 92 to 99% by mass and most preferably 93 to 98% by mass in view of the brightness and luminous efficiency of the element.

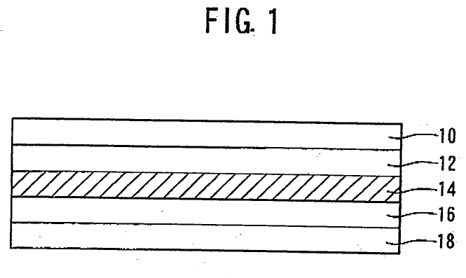

The layer structure of the luminous element of the invention is arbitrarily designed insofar as it has a luminous layer. However, the luminous element of the invention is provided preferably with at least a hole transfer layer, a luminous layer and an electron transfer layer, contains at least one compound which emits fluorescent light when voltage is applied in the luminous layer, wherein the rate of the emission from the compound which is contained in the luminous layer to emit fluorescent light is preferably 80% or more, more preferably 85% or more and particularly preferably 90% or more of the total emission from the element. One example of the layer structure of the luminous element of the invention is illustrated in FIG. 1, in which the symbols 10, 12, 14, 16 and 18 represent a metal electrode (cathode), an electron transfer layer, a luminous layer, a hole transfer layer and a transparent electrode (ITO, anode), respectively. The emissions obtained from the element include the emission from a sensitizer, emission from the host material, emission from the electron transfer layer and emission from the hole transfer layer other than the emission from the fluorescent light-emitting compound contained in the luminous layer.

A reduction in the ratio of the emission of the sensitizer is preferable in view of improving the response of the emission. Also, a reduction in the emissions from the host material, electron transfer layer and hole transfer layer equals to a reduction in the non-amplified emission and is therefore preferable in view of improving the efficiency of the element.

It is desirable that the luminous element of the invention emit light in the central part of the luminous layer. The emission of the luminous element in the center thereof is preferable in view that a reduction in external quantum efficiency is smaller than in the case where no material quenching triplet excitons exists even if compounds quenching triplet excitons exist in layers (hole transfer layer, exciton block layer (or hole block layer) and electron transfer layer) adjacent to the luminous layer. Specifically, a reduction in external quantum efficiency can be made to be within, for example, 20% and the emission in the center is therefore preferable. On the other hand, it is possible to estimate the position of the emission by this reduction in external quantum efficiency. In this case, the comparison of the both may be made by measuring the external quantum efficiency of the luminous element.

The glass transition temperature of the host material contained in the luminous layer according to the invention is preferably 90° C. or more and 400° C. or less, more preferably 100° C. or more and 380° C. or less, still more preferably 120° C. or more and 370° C. or less and particularly preferably 140° C. or more and 360° C. or less.

Next, organic electroluminescent element of the invention will be explained. The luminous element of the invention is not limited by a system, a driving method and the type of utilization. Typical examples of the luminous element may include organic EL (electroluminescent) elements.

Methods of forming the organic layer of the luminous element containing the compound represented by the formula (I) according to the invention are not particularly limited. Example of such methods include methods using resistance heating deposition, an electron beams or sputtering, a molecular lamination method, coating methods (e.g., a spray coating method, a dip coating method, an impregnation method, a roll coating method, a gravure coating method, a reverse coating method, a roll brush method, an air knife coating method, a curtain coating method, a spin coating method, a flow coating method, a bar coating method, a micro-gravure coating method, an air doctor coating method, a blade coating method, a squeeze coating method, a transfer roll coating method, a kiss-coating method, a cast coating method, an extrusion coating method, a wire bar coating method and a screen coating method), an inkjet method, a printing method and a transfer method. Among them, a method using resistance heating deposition, a coating method and a transfer method are preferable.

The luminous element of the invention is an element obtained by forming a luminous layer or plural organic compound films containing a luminous layer between a pair of electrodes, namely an anode and a cathode, and may have, besides the luminous layer, a hole injection layer, a hole transfer layer, an electron injection layer, an electron transfer layer, a protective layer and the like. Each of these layers may have other functions. Various materials may be used to form each layer.

The anode serves to supply holes to the hole injection layer, hole transfer layer and luminous layer. As the anode, a metal, alloy, metal oxide, electroconductive compound or a mixture of these materials may be used. A material having a work function of 4 eV or more is preferable. Specific examples of these materials include conductive metal oxides such as tin oxide, zinc oxide, indium oxide and indium tin oxide (ITO), metals such as gold, silver, chromium and nickel, mixtures or laminates of these metals and conductive metal oxides, inorganic conductive materials such as copper iodide and copper sulfide, organic conductive materials such as a polyaniline, polythiophene and polypyrrole and laminates of these materials and ITO. Among these materials, conductive metal oxides are preferable and ITO is particularly preferable in view of, for example, productivity, high conductivity and transparency. A suitable film thickness of the anode may be arbitrarily selected according to the material to be used, but is preferably in a range of 10 nm to 5 μm, more preferably 50 nm to 1 μm and still more preferably 100 nm to 500 nm.

As the anode, one prepared by forming a layer on, for example, a soda lime glass, non-alkali glass or transparent resin substrate is usually used. In the case of using glass, it is preferable to use non-alkali glass as the glass material to decrease ions eluted therefrom. Also, in the case of using soda lime glass, it is preferable to use one coated with a barrier layer comprising silica or the like. The thickness of the substrate is usually 0.2 mm or more and preferably 0.7 mm or more in the case of using glass though not particularly limited insofar as the thickness is enough to keep mechanical strength.

Various methods are used to produce the anode according to the type of material. In the case of, for example, ITO, an electron beam method, a sputtering method, a resistance heating deposition method, a chemical reaction method (sol-gel method) or a method of applying a dispersion of indium tin oxide is used to form a film.

It is possible to drop the driving voltage of the element and to raise the luminous efficiency by washing the anode or by treating the anode using other methods. In the case of, for example, ITO, UV-ozone treatment, plasma treatment or the like is effective.

The cathode serves to supply electrons to the electron injection layer, the electron transfer layer and the luminous layer. The material used for the cathode is selected in consideration of adhesion to layers, such as the electron injection layer, electron transfer layer and luminous layer adjacent thereto, ionization potential and stability. As the material of the cathode, a metal, alloy, metal halide, metal oxide, electroconductive compound or mixture of these materials may be used. Specific examples of the cathode material include alkali metals (e.g., Li, Na and K) and their fluorides and oxides, alkali earth metals (e.g., Mg and Ca) and their fluorides and oxides, gold, silver, lead, aluminum, sodium/potassium alloys or mixtures of these metals, lithium/aluminum alloys or mixtures of these alloys, magnesium/silver alloys or mixtures of these alloys and rare earth metals such as indium and ytterbium. A material having a work function of 4 eV or more is preferable and aluminum, lithium/aluminum alloys or mixtures of these metals and magnesium/silver alloys or mixtures of these metals are more preferable. The cathode may have not only a monolayer structure containing the above compound or mixtures but also a laminate structure containing the above compound or mires. For example, a laminate structure of aluminum/lithium fluoride or aluminum/lithium oxide is preferable. A suitable film thickness of the cathode may be selected according to the type of the cathode material to be used, but is preferably in a range from 10 nm to 5 μm, more preferably 50 nm to 1 μm and still more preferably 100 nm to 1 μm.

In the production of the cathode,a method such as an electron beam method, a sputtering method, a resistance heating deposition method, a coating method or a transfer method is used. As the cathodes a metal may be deposited singly or two or more components may be deposited simultaneously. Moreover, plural metals may be deposited simultaneously to form an alloy electrode or an alloy prepared in advance may be deposited.

Each sheet resistance of the anode and cathode is preferably lower and is preferably several hundreds Ω/sq or less.

Any material may be used as the material of the luminous layer insofar as it has the ability to inject holes from the anode or the hole injection layer and the hole transfer layer and to inject electrons from the cathode or the electron injection layer and the electron transfer layer, the ability to transfer the injected charges or the ability to provide a field where holes and electrons are recombined with each other to emit light. Examples of the material of the luminous layer include, besides the compound of the invention, benzoxazole, benzoimidazole, benzothiazole, styrylbenzene, polyphenyl, diphenylbutadiene, tetraphenylbutadiene, naphthalimide, cumarin, perylene, perinone, oxadiazole, ardazine, pyraridine, cyclopentadiene, bisstyrylanthracene, quinacridone, pyrrolopyridine, thiadiazolopyridine, cyclopentadiene, styrylamine, aromatic dimethylidyne compounds, various metal complexes typified by metal complexes of 8-quinolinol and rare earth complexes, polymer compounds such as a polythiophene, polyphenylene and polyphenylenevinylene, organic silane, iridium trisphenylpyridine complex, transition metal complexes typified by a platinum porphyrin complex and their derivatives. The film thickness of the luminous layer is not particularly limited, but preferably in a range of 10 nm to 5 μm, more preferably 5 nm to 1 μm, and still more preferably 10 nm to 500 nm.

Methods of producing the luminous layer are not particularly limited. Examples of such a method to be used include methods using resistance heating deposition, an electron beams or sputtering, a molecular laminating method, a coating method, an ink jet method, a printing method, an LB method or a transfer method. Among these methods, a method using resistance heating deposition or a coating method is preferable.

Either one luminous layer or plural luminous layers may be used in the luminous element of the invention and each luminous layer may emit a different color light to emit, for example, white light from the luminous element. A single luminous layer may emit white light.

Any material may be used as the material of the hole injection layer or hole transfer layer insofar as it has any of the ability to inject holes from the anode, the ability to transfer holes and the ability to form a barrier against electrons injected from the cathode. Specific examples of the material include carbazole, triazole, oxazole, oxadiazole, imidazole, polyarylalkane, pyrazoline, pyrazolone, phenylenedamine, arylamine, amino substituted calcon, styrylanthracene, fluorenone, hydrazone, stilbene, silazane, aromatic tertiary amine compound, styrylamine compound, aromatic dimethylidene type compound, porphyrin type compound, polysilane type compound, poly(N-vinylcarbazole), aniline type copolymer, thiophene oligomer, conductive high-molecular oligomer such as a polythiophene, organic silane, carbon film, the compound of the invention and derivatives of these compounds. Each film thickness of the hole injection layer and hole transfer layer is not particularly limited, but is preferably in a range from 1 nm to 5 μm, more preferably 5 nm to 1 μm and still more preferably 10 nm to 500 nm. The hole injection layer and the hole transfer layer may have either a monolayer structure comprising one or two or more of the above materials or a multilayer structure comprising plural layers having the same compositions or different compositions.

As a method of forming the hole injection layer and the hole transfer layer, a vacuum deposition method, an LB method, a method in which the aforementioned hole injection or transfer materials are dissolved or dispersed in a solvent and the resulting solution is used for coating, an ink jet method, a printing method or a transfer method is used. In the case of the coating method, these materials may be dissolved or dispersed together with a resin component. Examples of the resin component include a polyvinyl chloride, polycarbonate, polystyrene, polymethylmethacrylate, polybutylmethacrylate, polyester, polysulfone, polyphenylene oxide, polybutadiene, poly(N-vinylcarbazole), hydrocarbon resin, ketone resin, phenoxy resin, polyamide, ethyl cellulose, vinyl acetate, ABS resin, polyurethane, melamine resin, unsaturated polyester resin, alkyd resin, epoxy resin and silicon resin.

Any material may be used as the material of the electron injection layer or electron transfer layer insofar as it has any of the ability to inject electrons from the cathode, the ability to transfer electrons and the ability to form a barrier against holes injected from the anode. Specific examples of the material include triazole, oxazole, oxadiazole, imidazole, fluorenone, anthraquinonedimnethane, anthrone, diphenylquinone, thiopyran dioxide, carbodiimide, fluorenylidenemethane, distyrylpyrazine, naphthalene, aromatic cyclic tetracarboxylic acid anhydride such as perylene, phithalocyanine, metal complexes and metal phthalocyanines of 8-quinolinol, various metal complexes represented by metal complexes containing, as a ligand, benzoxazole or benzotiazole, organic silanes such as sylol and their derivatives. Each film thickness of the electron injection layer and electron transfer layer is not particularly limited, but is preferably in a range from 1 nm to 5 μm, more preferably 5 nm to 1 μm and still more preferably 10 mn to 500 nm. The electron injection layer and the electron transfer layer may have either a monolayer structure comprising one or two or more of the above materials or a multilayer structure comprising plural layers having the same compositions or different compositions.

As a method of forming the electron injection layer and the electron transfer layer, a vacuum deposition method, an LB method, a method in which the aforementioned electron injection or transfer materials are dissolved or dispersed in a solvent and the resulting solution is used for coating, an ink jet method, a printing method or a transfer method is used. In the case of the coating method, these materials may be dissolved or dispersed together with a resin component. As the resin component, those given as the examples in the case of the hole injection or transfer layer may be used.

Any material may be used as the material of the protective layer insofar as it has the ability to prevent the intrusion of materials, such as water and oxygen, which promote the deterioration of the element, into the element. Specific examples of the material of the protective layer include metals such as In, Sn, Pb, Au, Cu, Ag, Al, Ti and Ni, metal oxides such as MgO, SiO, SiO₂, Al₂O_{3,} GeO, NiO, CaO, BaO, Fe₂O₃; Y₂O₃ and TiO₂, metal fluorides such as MgF₂, LiF, AlF₃ and CaF₂, nitrides such as SiNₓ and SiOₓN_{y}, polyethylene, polypropylene, polymethylmethacrylate, polyimide, polyurea, polytetrafluoroethylene, polychlorotrifluoroethylene, polydichlorodifluoroethylene, copolymer of chlorotrifluoroethylene and dichlorodifluoroethylene, copolymers obtained by copolymerizing a monomer mixture containing tetrafluroethylene and at least one comonomer, fluorine-containing copolymers having a cyclic structure on their principal chains, water absorptive materials having a water absorption of 1% or more and a moisture-proof material having a water absorption of 0.1% or less.

Methods of forming the protective layer are not particularly limited. Examples of such a method to be used include a vapor deposition method, a sputtering method, a reactive sputtering method, an MBE (molecular ray epitaxial) method, a cluster ion-beam method, an ion plating method, a plasma polymerization method (hygh frequency excitation ion plating method), a plasma CVD method, a laser CVD method, a thermal CVD method, a gas source CVD method, a coating method, a printing method or a transfer method.

The luminous element of the invention may be improved in the light ejection efficiency by various known devices. Specifically, it is possible to improve the light ejection efficiency to thereby improve external quantum efficiency by, for example, processing the surface shape of the substrate (for example, forming a fine irregular pattern), controlling the refractive index of the substrate/ITO layer/organic layer or controlling the film thickness of the substrate/ITO layer/organic layer.

The luminous element of the invention may be used in a so-called top emission system in which light is emitted from the anode side.

Examples of the base material used in the luminous element of the invention may not particularly be limited, but include inorganic materials such as zirconia stabilized yttrium and glass, polyesters such as a polyethylene terephthalate, polybutylene terephthalate and polyethylene naphthalate and high-molecular weight materials such as a polyethylene, polycarbonate, polyether sulfone, polyarylate, allyl diglycol carbonate, polyimide, polycycloolefin, norbornane resin, poly(chlorotrifluoroethylene), Teflon (R) and polytetrauoroethylene/polyethylene copolymer.

### EXAMPLES

The present invention will be explained with reference to the following examples. However, the following examples should not be construed to limit the scope of the invention.

### Example 1

1. Production of a Luminous Element

A washed ITO substrate was placed in a vapor deposition apparatus to deposit TPD (N,N′-diphenyl-N,N′-di(m-natryl)-benzidine with a thickness of 50 nm. On this TPD, the exemplified compound (5) and rubrene were deposited in a ratio of 99:1 with a thickness of 1 nm and the exemplified compound (5) and Ir(ppy)₃ (the following structure) were deposited in a ratio of 17:1 thereon with a thickness of 1 nm. This process was repeated 18 times to form a thin film having a total thickness of 36 nm. At this time, a crucible charged with the exemplified compound (5) and rubrene and a crucible charged with the exemplified compound (5) and Ir(ppy)₃ were heated to a temperature enough to deposit always and were deposited repeatedly by switching using a shutter disposed in the vicinity of the crucibles. A compound C (the following structure) with a thickness of 36 nm was deposited on the formed thin film.

A patterned mask (a mask with an emitting area of 4 mm×5 mm) was disposed on the resulting organic thin film and lithium fluoride with a thickness of 3 nm was deposited on the organic thin film. Aluminum with a thickness of 200 nm was deposited thereon to obtain a luminous element (EL element) of Example 1. 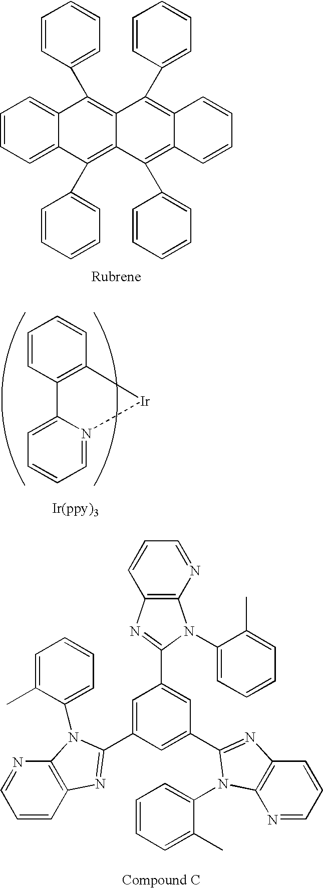
2. Evaluation of the Luminous Element

Using a Source Measure Unit 2400 Model manufactured by TOYO Corporation, DC constant voltage was applied to the EL element of Example 1 to allow the element to emit light and the brightness was measured using a luminance meter BM-8 manufactured by TOPCON Corporation.

As a result, yellow luminescence (λmax=565 nm, chromaticity (x, y)=(0.44, 0.54)) was obtained and the external quantum efficiency at 200 cd/m² was 11.1%.

### Example 2

An EL element was produced in the same manner as in Example 1 except that the exemplified compound (8) was used in place of the exemplified compound (5) in Example 1 and evaluated in the same manner.

As a result, yellow luminescence was obtained and the external quantum efficiency at 200 cd/m² was 12.0%.

### EXAMPLE 3

An EL element was produced in the same manner as in Example 1 except that the exemplified compound (10) was used in place of the exemplified compound (5) in Example 1 and evaluated in the same manner.

As a result, yellow luminescence was obtained and the external quantum efficiency at 200 cd/m² was 13.5%.

### Example 4

An EL element was produced in the same manner as in Example 1 except that the exemplified compound (16) was used in place of the exemplified compound (5) in Example 1 and evaluated in the same manner.

As a result, yellow luminescence was obtained and the external quantum efficiency at 200 cd/m² was 14.2%.

### Example 5

An EL element was produced in the same manner as in Example 1 except that the exemplified compound (19) was used in place of the exemplified compound (5) in Example 1 and evaluated in the same manner.

As a result, yellow luminescence was obtained and the external quantum efficiency at 200 cd/m² was 9,1%.

### Example 6

An EL element was produced in the same manner as in Example 1 except that the exemplified compound (24) was used in place of the exemplified compound (5) in Example 1 and evaluated in the same manner.

As a result, yellow luminescence was obtained and the external quantum efficiency at 200 cd/m² was 12.2%.

### Example 7

An EL element was produced in the same manner as in Example 1 except that the exemplified compound (30) was used in place of the exemplified compound (5) in Example 1 and evaluated in the same manner.

As a result, yellow luminescence was obtained and the external quantum efficiency at 200 cd/m² was 13.3%.

### Example 8

An EL element was produced in the same manner as in Example 1 except that the exemplified compound (31) was used in place of the exemplified compound (5) in Example 1 and evaluated in the same manner.

As a result, yellow luminescence was obtained and the external quantum efficiency at 200 cd/m² was 12.9%.

### Example 9

An EL element was produced in the same manner as in Example 1 except that the exemplified compound (34) was used in place of the exemplified compound (5) in Example 1 and evaluated in the same manner.

As a result, yellow luminescence was obtained and the external quantum efficiency at 200 cd/m² was 12.4%.

### Example 10

An EL element was produced in the same manner as in Example 1 except that the exemplified compound (37) was used in place of the exemplified compound (5) in Example 1 and evaluated in the same manner.

As a result, yellow luminescence was obtained and the external quantum efficiency at 200 cd/m² was 8.5%.

### Example 11

An EL element was produced in the same manner as in Example 1 except that the exemplified compound (38) was used in place of the exemplified compound (5) in Example 1 and evaluated in the same manner.

As a result, yellow luminescence was obtained and the external quantum efficiency at 200 cd/m² was 10.0%.

### Example 12

An EL element was produced in the same manner as in Example 1 except that the exemplified compound (42) was used in place of the exemplified compound (5) in Example 1 and evaluated in the same manner.

As a result, yellow luminescence was obtained and the external quantum efficiency at 200 cd/m² was 7.8%.

### Example 13

An EL element was produced in the same manner as in Example 1 except that the exemplified compound (48) was used in place of the exemplified compound (5) in Example 1 and evaluated in the same manner.

As a result, yellow luminescence was obtained and the external quantum efficiency at 200 cd/m² was 11.9%.

### Example 14

An EL element was produced in the same manner as in Example 1 except that the exemplified compound (54) was used in place of the exemplified compound (5) in Example 1 and evaluated in the same manner.

As a result, yellow luminescence was obtained and the external quantum efficiency at 200 cd/r² was 7.0%.

### Example 15

An EL element was produced in the same manner as in Example 1 except that the exemplified compound (56) was used in place of the exemplified compound (5) in Example 1 and evaluated in the same manner.

As a result, yellow luminescence was obtained and the external quantum efficiency at 200 cd/m² was 6.7%.

### Comparative Example 1

1. Production of the Luminous Element Described in International Patent Application Publication No. 2001/008230

The above-mentioned International Patent Application Publication No.2001/ 008230 was adopted as a reference to produce the optical element described there as Comparative Example 1.

A washed ITO substrate was placed in a vapor deposition apparatus to deposit TPD (N,N′-diphenyl-N,N′-di(m-natryl)-benzidine) with a thickness of 60 nm. On this TPD, CBP (the following structure) and DCM2 (the following structure) were deposited in a ratio of 99:1 (mass ratio) with a thickness of 1 nm and CPB and Ir(ppy)₃ were deposited in a ratio of 90:10 thereon with a thickness of 1 nm. This process was repeated 5 times to form an alternate laminate film having 10 layers to a total thickness of 10 nm. On the alternate laminate film, BCP (the following structure) with a thickness of 20 nm was deposited and Alq (the following structure) with a thickness of 30 nm was deposited thereon. A patterned mask (a mask with an emitting area of 4 mm×5 mm) was disposed on the resulting organic in film and magnesium and silver were deposited in a ratio of 25:1 with a thickness of 100 nm on the organic thin film in a vapor deposition apparatus. Silver with a thickness of 50 nm was deposited thereon to obtain an EL element of Comparative Example 1.

2. Evaluation of the Luminous Element

Using a Source Measure Unit 2400 Model manufactured by TOYO Corporation, DC. constant voltage was applied to the EL element to allow the element to emit light and the brightness was measured using a luminance meter BM-8 manufactured by TOPCON Corporation.

As a result, red luminescence was obtained and the external quantum efficiency at 200 cd/m² was 2.6%. It was also found from the emission spectrum that the emission was not only the emission from DCM2 but also a mixture of the emissions from Ir(ppy)₃ and CBP. The results of this evaluation were the same as the results described in International Patent Application Publication No. 2001/008230.

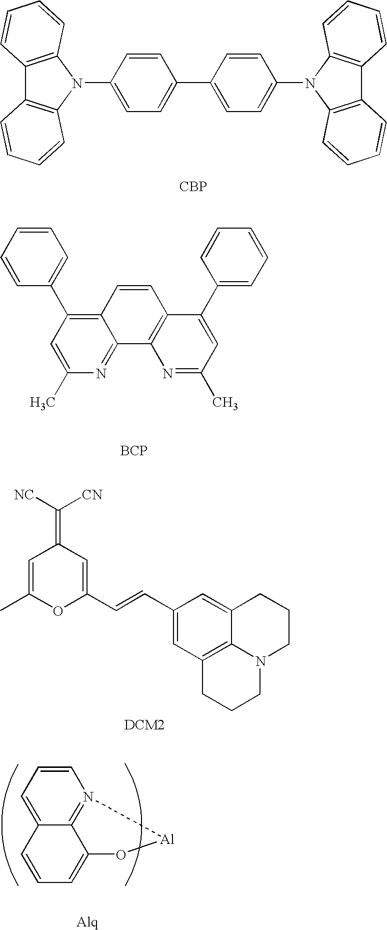

### Comparative Example 2

1. Production of a Luminous Element

A washed ITO substrate was placed in a vapor deposition apparatus to deposit TPD (N,N′-diphenyl-N,N′-di(m-natryl)-benzidine) with a thickness of 50 nm. On this TPD, CBP and rubrene were deposited in a ratio of 99:1 with a thickness of 1 nm and CBP and Ir(ppy)₃ were deposited in a ratio of 17:1 thereon with a thickness of 1 nm. This process was repeated 18 times to form a thin film having a total thickness of 36 nm. At this time, a crucible charged with CBP and rubrene and a crucible charged with CBP and Ir(ppy)₃ were heated to a temperature enough to deposit always and were deposited repeatedly by switching using a shutter disposed in the vicinity of the crucibles. A compound C with a thickness of 36 nm was deposited on the formed thin film.

A patterned mask (a mask with an emitting area of 4 mm×5 mm) was disposed on the resulting organic thin film and lithium fluoride with a thickness of 3 nm was deposited on the organic thin film. Aluminum with a thickness of 200 nm was deposited thereon to obtain a luminous element (EL element) of Comparative Example 2.

2. Evaluation of the Luminous Element

Using a Source Measure Unit 2400 Model manufactured by TOYO Corporation, DC. constant voltage was applied to the EL element to allow the element to emit light and the brightness was measured using a luminance meter BM-8 manufactured by TOPCON Corporation.

As a result, yellow luminescence (λmax=563 nm, chromaticity (x, y) =(0.43, 0.54)) was obtained and the external quantum efficiency at 200 cd/m² was 6.5%. As mentioned above, sufficient luminous efficiency was not obtained in Comparative Example 2, in which the sample was prepared in the same manner as in Example 1 except that the exemplified compound (5) was replaced by CBP.

It was found from the results of the above Examples and Comparative Examples that all of the luminous elements of the invention which comprised a noncomplex compound represented by the formula (I) as the host material in the luminous layer had a higher luminous efficiency than the elements obtained in Comparative Examples 1 and 2 using CBP which had a skeleton similar to that of the noncomplex compound but had the same structure as the compound (X), which is out of the scope of the present invention.

The luminous element of the invention may be used preferably in the fields of a display element, display, back-light, electrophotography, illumination source, recording light source, exposure light source, reading light source, indicator, signboard, interior and optical communication.

1. An organic electroluminescent element comprising: a pair of electrodes and one or more organic compound layers including a luminous layer, the one or more organic compound layers being disposed between the pair of electrodes, wherein:
the luminous layer comprises at least one compound that emits fluorescent light when voltage is applied,
the one or more organic compound layers comprise a compound having a function of amplifying the number of singlet excitons generated when voltage is applied so as to amplify luminous intensity of the fluorescent light emitted from the compound that emits fluorescent light, and
the luminous layer comprises at least one noncomplex compound represented by the following formula (I) as a host material: 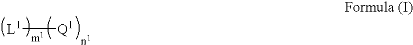
wherein L¹ represents a connecting group, Q¹ represents a substituent, m¹ denotes 0 or 1, n¹ denotes an integer of 1 or more, and a plurality of Q¹s may be the same or different, provided that the formula (I) does not represent the following compound (X):

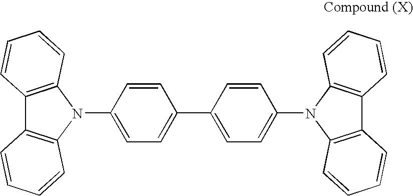

2. The organic electroluminescent element of claim 1, wherein the compound represented by the formula (I) is represented by the following formula (A-I): 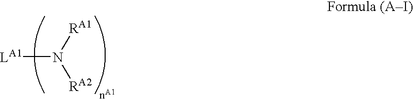
wherein L^{A1} represents a connecting group; R^{A1} and R^{A2} each independently represent an aliphatic hydrocarbon group, an aryl group or an aromatic heterocyclic group; R^{A1} and L^{A1}, and/or R^{A2} and L^{A1} may be bonded to each other to form a ring, provided that R^{A1} and R^{A2} are not bonded to each other to form a ring; and n^{A1} denotes an integer of 2 or more.

3. The organic electroluminescent element of claim 1, wherein the compound represented by the formula (I) is represented by the following formula (B-I): 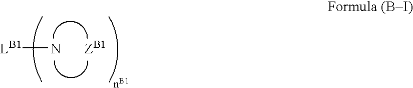
wherein Z^{B1} represents an atomic group necessary for forming a nitrogen-containing hetero-ring, L^{B1} represents a connecting group, and n^{B1} denotes an integer of 2 or more.

4. The organic electroluminescent element of claim 3, wherein the nitrogen-containing hetero-ring comprising Z^{B1} is at least one selected from the group consisting of an indole ring, a carbazole ring, a benzoimidazole ring and a tribenzoazepin ring.

5. The organic electroluminescent element of claim 1, wherein the compound represented by the formula (I) is represented by the following formula (C-I): 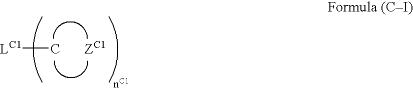
wherein Z^{C1} represents an atomic group necessary for forming an aromatic hydrocarbon ring or a hetero-ring, L^{C1} represents a connecting group, and n^{C1} denotes an integer of 2 or more.

6. The organic electroluminescent element of claim 5, wherein Z^{C1} is an atomic group necessary for forming an aromatic hydrocarbon ring, and the aromatic hydrocarbon ring comprising Z^{C1} is at least one selected from the group consisting of a benzene ring, a naphthalene ring, a phenanthrene ring and a triphenylene ring.

7. The organic electroluminescent element of claim 5, wherein Z^{C1} is an atomic group necessary for forming an aromatic hetero-ring, and the aromatic hetero-ring comprising Z^{C1}, is at least one selected from the group consisting of a pyridine ring, a pyrazine ring, a triazine ring, a benzoxazole ring, a benzothiazole ring, a benzoimidazole ring, a pyrazole ring, a furan ring, a thiophene ring, a pyrrole ring, an indole ring and an imidazopyridine ring.

8. The organic electroluminescent element of claim 1, wherein the compound having a function of amplifying luminous intensity of the fluorescent light emitted from the compound that emits fluorescent light is a transition metal complex.

9. The organic electroluminescent element of claim 8, wherein the transition metal complex comprises at least one selected from the group consisting of an iridium complex, a platinum complex, a rhenium complex, a ruthenium complex, a palladium complex, a rhodium complex, a copper complex and a rare earth complex.

10. The organic electroluminescent element of claim 1, wherein the compound having a function of amplifying the luminous intensity of the fluorescent light emitted from the compound that emits fluorescent light is contained in the one or more organic compound layers in an amount of 0.1 to 9% by mass based on the mass of the one or more organic compound layers.

11. The organic electroluminescent element of claim 1, wherein a fluorescent light quantum yield of the compound that emits fluorescent light is 70% or more.

12. The organic electroluminescent element of claim 1, wherein the compound that emits fluorescent light comprises at least one selected from the group consisting of benzoxazole, benzoimidazole, benzothiazole, styrylbenzene, polyphenyl, diphenylbutadiene, tetraphenylbutadiene, naphthalimide, cumarin, perylene, perinone, oxadiazole, ardazine, pyraridine, cyclopentadiene, bisstyrylanthracene, rubrene, quinacridone, pyrrolopyridine, thiadiazolopyridine, styrylamine, aromatic dimethylidyne compounds, metal complexes of 8-quinolinol, polythiophene, polyphenylene, polyphenylenevinylene and the derivatives thereof.

13. The organic electroluminescent element of claim 1, wherein the compound that emits fluorescent light is contained in the luminous layer in an amount of 0.0001 to 20% by mass based on the mass of the luminous layer.

14. A display including an organic electroluminescent element, wherein the organic electroluminescent element comprises:
a pair of electrodes and one or more organic compound layers including a luminous layer, the one or more organic compound layers being disposed between the pair of electrodes, wherein:
the luminous layer comprises at least one compound that emits fluorescent light when voltage is applied,
the one or more organic compound layers comprise a compound having a function of amplifying the number of singlet excitons generated when voltage is applied so as to amplify luminous intensity of the fluorescent light emitted from the compound that emits fluorescent light, and
the luminous layer comprises at least one noncomplex compound represented by the following formula (I) as a host material: 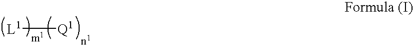
wherein L¹ represents a connecting group, Q¹ represents a substituent, m¹ denotes 0 or 1, n¹ denotes an integer of 1 or more, and a plurality of Q¹ s may be the same or different, provided that the formula (I) does not represent the following compound (X): [chemical structure]
